(19) United States
(12) Patent Application Publication
(10) Pub. No.: US 2004/0212590 A1
(43) Pub. Date: Oct. 28, 2004

(54) 3D-input device and method, soft key mapping method therefor, and virtual keyboard constructed using the soft key mapping method

(75) Inventors: Ji-hun Koo, Yongin-si (KR); Sang-goog Lee, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/830,043

(22) Filed: Apr. 23, 2004

(30) Foreign Application Priority Data
Apr. 23, 2003 (KR) 2003-25715

(51) Int. Cl. G09G 5/00

(52) U.S. Cl. 345/156

(57) ABSTRACT

A ventilation interface and system is described which can be adapted to be connected to a source of ventilation. The ventilation interface and system includes an exhaust port positioned at a midpoint between at least two ventilation connectors. The ventilation interface system may optionally include feed tubes, y-connector, tube holder, and headgear.

### BACKGROUND OF THE INVENTION

This application is based upon and claims the benefit of priority from Korean Patent Application No. 2003-25715, filed on Apr. 23, 2003, in the Korean Intellectual Property Office, the disclosure of which is incorporated herein in its entirety by reference.

1. Field of the Invention

The present invention relates to a three-dimensional (3D)-input device and method, a soft key mapping method therefore, and a virtual keyboard constructed using the mapping method, and more particularly, to a 3D-input device and method, a soft key mapping method therefore, and a virtual keyboard for efficiently inputting data to a device in a wearable or mobile computing environment.

2. Description of the Related Art

Recently, information input devices that are worn on the hand for inputting information spatially in a wearable or mobile computing environment are being developed. Examples of such information input devices include clickure sensor gloves, finger rings that sense movements of the fingers using optical fibers, and air gloves. These data input devices are based on a virtual QWERTY keyboard like that shown in FIG. 1. In a QWERTY keyboard, which is the current standard keyboard, one bit corresponds to one button and one character corresponds to the one bit.

In the virtual QWERTY keyboard, input information is determined by discriminating a movement of a hand from movements of the fingers, but there are the following problems. First, precise movements of the hand and the fingers are required. Namely, a user is required to learn exact finger positions on the keyboard. It is difficult because the QWERTY keyboard has many keys to be displayed and the input device adopting an inertial sensor is sensitive to movements of the hands and fingers. Thus, in using the virtual QWERTY keyboard, an error rate for a click motion is low, but an error rate for selecting information through movement of the hands and fingers is high.

Second, a key may be duplicably mapped to each different finger, as shown in FIGS. 2A through 2C. For example, when a key is input through 3 fingers, the “h” can be input using a right side finger in a case of FIG. 2A, using the middle finger in a case of FIG. 2B, and using the left side finger in a case of FIG. 2C according to a hand position. Here, since there are three possibilities for inputting one key, the speed of inputting information is lowered and the difficultly of learning the keyboard is increased. Also, since a key can be input by using different fingers, not using a single fixed finger, there exist problems that the fingers are used inefficiently in view of function and key combination is not necessary. Therefore, it is necessary to improve a conventional information input scheme, which maps a single character to a single key and has the corresponding key to be clicked to input information.

### SUMMARY OF THE INVENTION

The invention provides a 3D-input device and method, a soft key mapping method therefor, and a virtual keyboard constructed using the mapping method, by which a plurality of characters are mapped onto each key and input information is determined by distinguishing a sequence of fingers clicking the key.

According to an aspect of the present invention, there is provided a 3D-input device for inputting information using a virtual keyboard including: a hand position and finger order determination unit that determines: a selected button, of a plurality of buttons of the virtual keyboard, that is selected by a user; and an order of the user's fingers used to select the selected button; a key information storage unit that stores key values respectively mapped to both a predefined button of the plurality of buttons of the virtual keyboard and a predefined order of the user's fingers used to select the predefined button; and a key determination unit that finds a selected key value by matching the selected button and order of the user's fingers with the predefined button and predefined order of the user's fingers mapped in the key information storage unit

According to another aspect of the present invention, there is provided a 3D-input method for inputting information using a virtual keyboard including: sensing the selection of a virtual button of the virtual keyboard by a user; sensing positions of the user's fingers relative to the virtual button, and the order of the user's fingers that are used to select the virtual button; and identifying a selected key value corresponding to the sensed positions of the fingers and the order of the user's fingers that are used to select the virtual button, amongst a plurality of stored key values

According to another aspect of the present invention, there is provided a soft key mapping method for mapping keys onto virtual buttons of a virtual keyboard that are selected by a user's fingers upon which are individually mounted a plurality of sensors, the method comprising: determining the number of sensors; allocating key values according to the number of sensors; mapping the allocated key values onto a first virtual button; and repeating the determining, allocating and mapping for the remaining virtual buttons.

According to another aspect of the present invention, there is provided a virtual keyboard comprising a plurality of virtual buttons selectable by a user's fingers upon which are mounted a plurality of sensors, the virtual keyboard constructed by mapping key values onto each of the virtual buttons and arranging the virtual buttons according to a predetermined condition using a method comprising: determining the number of sensors; allocating key values to the number of sensors; mapping the allocated key values onto a first virtual button; and repeating the determining, allocating and mapping for the remaining virtual buttons.

### BRIEF DESCRIPTION OF THE DRAWINGS

The above and other features and advantages of the present invention will become more apparent by describing in detail exemplary embodiments thereof with reference to the attached drawings in which:

FIG. 1 is a view of a conventional QWERTY keyboard;

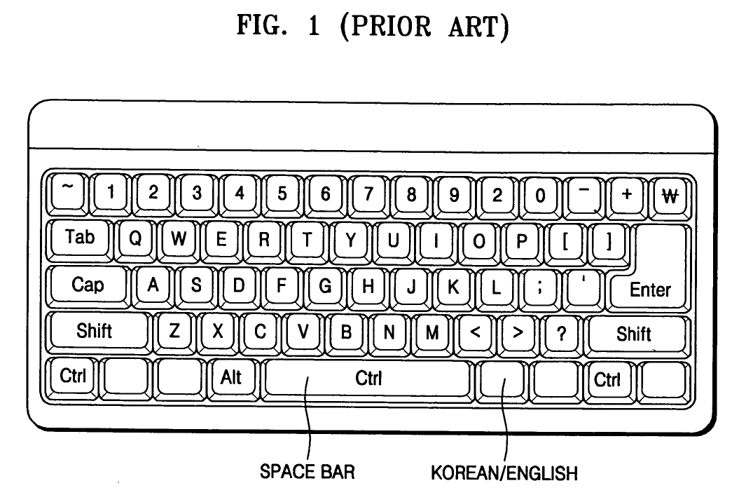

FIGS. 2A through 2C show selection of the same key using different fingers in a conventional virtual keyboard;

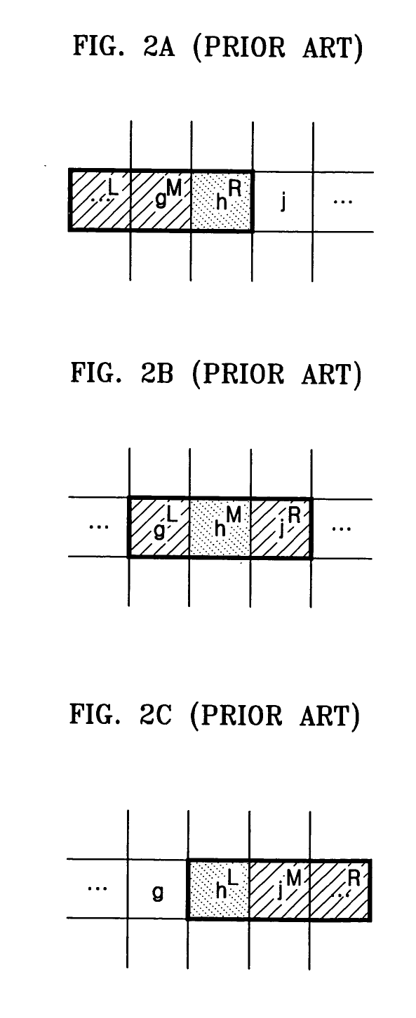

FIG. 3 is a block diagram of an exemplary 3D-input device according to the invention;

FIG. 4 shows examples of cases according to clicks performed by each finger when using 3 fingers and key values allocated to a single button thereby;

FIG. 5 shows examples of cases according to clicks performed by each finger when using 2 fingers and key values allocated to a single button thereby; and

FIGS. 6A through 6D show examples of various key values of buttons that may be mapped when a plurality of fingers are used.

### DETAILED DESCRIPTION OF THE INVENTION

Exemplary embodiments of the invention will now be described below by reference to the attached Figures. The described exemplary embodiments are intended to assist the understanding of the invention, and are not intended to limit the scope of the invention in any way.

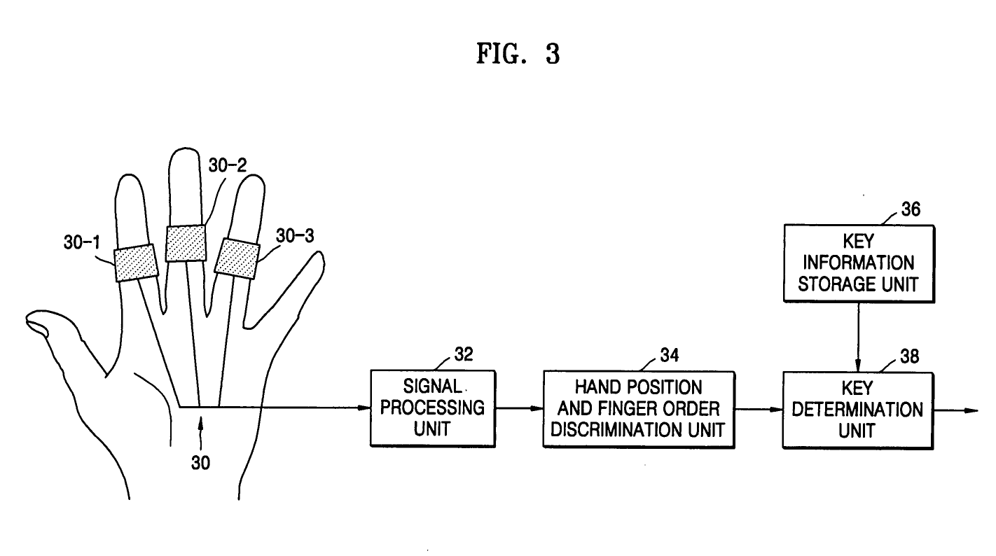

FIG. 3 is a block diagram of a three-dimensional (3D)-input device according to the present invention. The 3D-input device of FIG. 3 comprises a sensing device 30, a signal processing unit 32, a hand position and finger order determination unit 34, a key information storage unit 36, and a key determination unit 38. The 3D-input device is based on a virtual keyboard, and, herein, a button means a soft key button.

The sensing device 30 comprises a plurality of sensors 30-1, 30-2, and 30-3 which can be mounted or worn on respective fingers. Alternatively, the sensing device 30 may be formed as a glove on which sensors are disposed on appropriate portions of fingers. The sensors 30-1, 30-2, and 30-3 sense the movement of their respective fingers to output a signal for inputting or selecting information. Any kind of sensors that are capable of sensing finger movement can be used as the sensors 30-1, 30-2 and 30. Examples of these sensors include: sensors that output a digital signal, such as inertial sensors; sensors that output an analog signal, such as potentiometers; giant magnetoresistive (GMR) sensors; optical sensors; on/off switches; and clickure sensors.

The signal processing unit 32 receives and processes the signal output from the sensors 30-1, 30-2, and 30-3 in a wired or wireless way, to recognize the positions of the respective sensors 30-1, 30-2, and 30-3 and to extract information on movement of the fingers.

The hand position and finger order determination unit 34 determines a hand position and which finger among the sensor mounted fingers is used to click a button, based on information indicating sensor positions and finger movements extracted by the signal processing unit 32.

The key information storage unit 36 stores a key value that corresponds to which finger or fingers are used to click the button.

The key determination unit 38 determines a key value corresponding to the presently clicked button with reference to the key values stored in the key information storage unit 36, and inputs the key value to an object device (not shown). The key values stored in the key information storage unit 36 are now described. A key value is determined according to an order of fingers clicking the button, namely, which one of the fingers in order is used to click the button. In the case of using n fingers, there are (2n-1) cases according to an order of the n fingers that can be used to click keys and keys can be allocated to each case that is designated by a user.

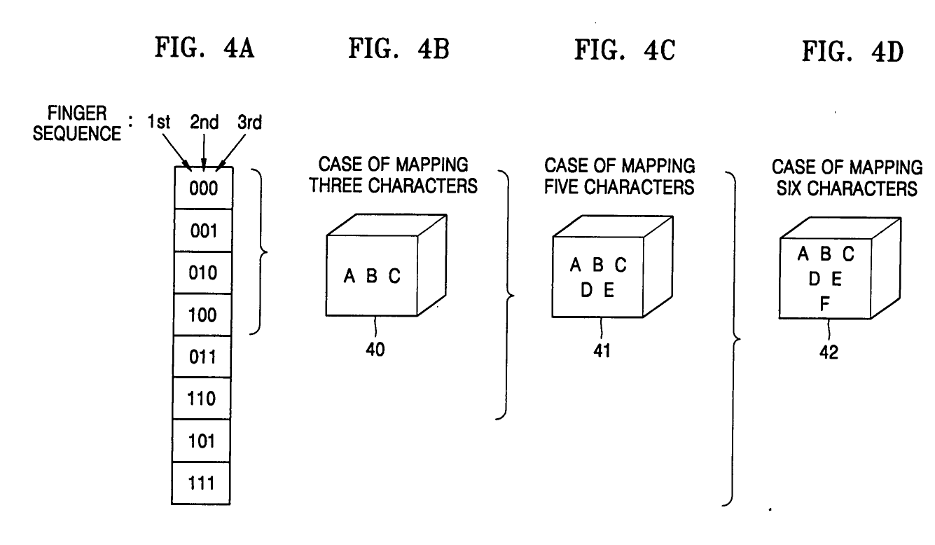

FIG. 4 shows examples of cases according to clicks performed by each finger when using 3 fingers and key values allocated to a single button thereby. Specifically, FIG. 4(a) shows cases when clicks are performed by each one of the 3 fingers, FIG. 4(b) shows a case of three characters mapped onto a button 40, FIG. 4(c) shows a case of five characters mapped onto a button 41, and FIG. 4(d) shows a case of six characters mapped onto a key 42. In the case shown in FIG. 4(b), the key value can be mapped as C when the button 40 is clicked using only the third finger, B when the button 40 is clicked using only the second finger, and A when the button 40 is clicked using only the first finger. Subsequently, the 3 characters can be mapped onto the single button 40. In the case shown in FIG. 4(c), besides the key values mapped in the case shown in FIG. 4(b), two more characters can be mapped by clicking the button 41 substantially simultaneously using two fingers. For example, D when the button 41 is clicked substantially simultaneously using the second and third fingers, and E when the button 41 is clicked substantially simultaneously using the first and second fingers. The case shown in FIG. 4(d) is the same as the case of FIG. 4(c), except that the key value F is further mapped to the button 42, corresponding to when the button 42 is clicked substantially simultaneously using the first and third fingers. Although not shown in FIG. 4, a seventh character, G, could be mapped onto the button 42, corresponding to clicking the button 42 substantially simultaneously using all three fingers. Subsequently, all 7 characters can be mapped onto the single button 42.

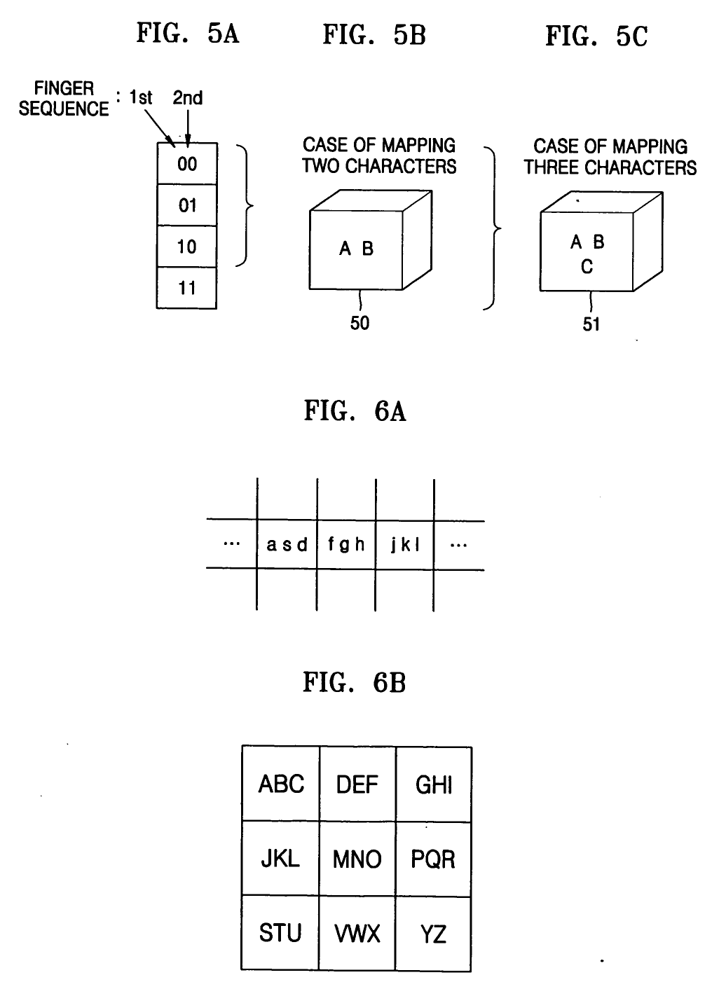

FIG. 5 shows examples of cases according to clicks performed by each finger when using 2 fingers and key values allocated to a single button thereby. Specifically, FIG. 5(a) shows cases when clicks are performed by each one of the 2 fingers, FIG. 5(b) shows a case of two characters mapped onto a button 50, and FIG. 5(c) shows a case of three characters mapped onto a button 51. In the case shown in FIG. 5(b), the key value is B when the button 50 is clicked using only the second finger, and A when the button 50 is clicked using only the first finger. Subsequently, the 2 characters can be mapped onto the single button 50. In the case shown in FIG. 5(c), besides the key values mapped in the case shown in FIG. 5(b), C can be additionally mapped onto the button 51 by clicking the button 51 substantially simultaneously using the first and second fingers.

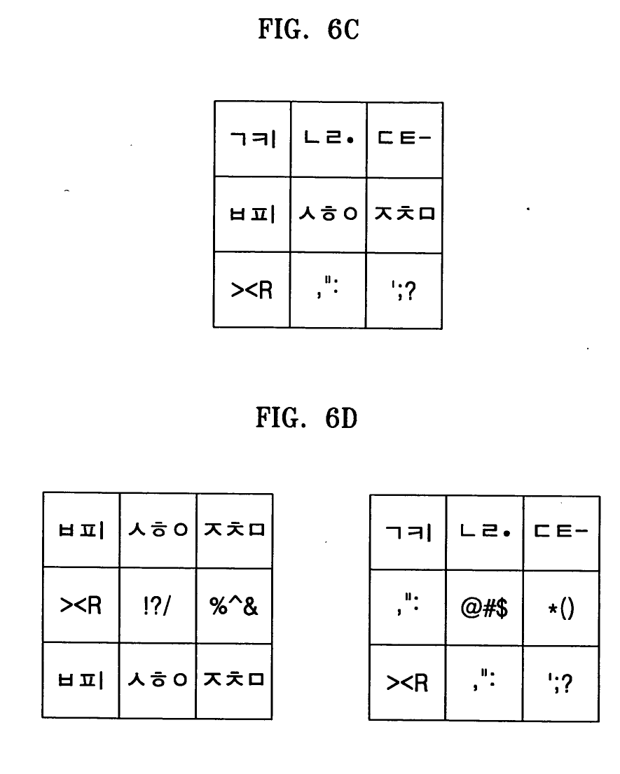

FIGS. 6A through 6D show examples of various key values of buttons that may be mapped when a plurality of fingers are used. FIG. 6A shows a case in which every three (3) characters in the same order as the ones on the QWERTY keyboard are mapped onto each button. FIG. 6B shows a case in which every three (3) English characters are mapped onto each button in alphabetical order. FIG. 6C shows a case in which Korean vowels and consonants, and other symbols, are mapped onto nine buttons. Here, the Korean vowels and consonants only require six buttons. The remaining three (3) buttons can be mapped as defined by a user. FIG. 6D shows a case which can be realized as a case of using both hands. As shown in FIG. 6D, special characters or frequently used characters can be double mapped to more than one button for the sake of convenience. These key mappings may be performed according to frequencies of the uses of characters, digits or special characters.

According to the present invention, a plurality of characters can be mapped onto one button by distinguishing an order of fingers clicking the button. Thus, the number of buttons required to represent a given number of characters can be reduced, making more efficient use of space, typing speed can be increased by enhancing key combinations, and minimizing dependence on sensor movements.

A method for discriminating key values according to an order of fingers clicking a button is described as an embodiment of the invention, when the button is clicked by two (2) or three (3) fingers. The number of characters mapped onto each button or an order of characters arrangement may be varied according to the number of fingers used to click a button or a click frequency of a button.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the following claims.

What is claimed is:

1. A 3D-input device for inputting information using a virtual keyboard, comprising:
a hand position and finger order determination unit that determines: a selected button, of a plurality of buttons of the virtual keyboard, that is selected by a user; and an order of the user's fingers used to select the selected button;
a key information storage unit that stores key values respectively mapped to both a predefined button of the plurality of buttons of the virtual keyboard and a predefined order of the user's fingers used to select the predefined button; and
a key determination unit that finds a selected key value by matching the selected button and order of the user's fingers with the predefined button and predefined order of the user's fingers mapped in the key information storage unit.

2. The device of claim 1, wherein the key determination unit outputs the selected key value.

3. The device of claim 1, further comprising:
a sensing device that senses a user's finger movements; and
a signal processing unit that processes a signal output from the sensing device to detect the movement of the user's fingers,
wherein the hand position and finger order determination unit utilizes information output by the signal processing unit to determine the selected button and the order of the user's fingers.

4. The device of claim 3, wherein the sensing device comprises a plurality of sensors arranged individually on a user's fingers.

5. The device of claim 4, wherein, in the key information storage unit, key values are allocated to each of the plurality of buttons of the virtual keyboard based upon the number of sensors.

6. The device of claim 1, wherein the virtual buttons are arranged so that the key values are ordered by frequency of use.

7. The device of claim 1, wherein the virtual buttons are arranged so that the key values are in alphabetical order.

8. The device of claim 1, wherein the virtual buttons include key values that are defined by the user.

9. The device of claim 1, wherein each virtual button comprises two key values.

10. The device of claim 1, wherein each virtual button comprises three key values.

11. The device of claim 1, wherein each virtual button comprises four key values.

12. The device of claim 1, wherein each virtual button comprises five key values.

13. The device of claim 1, wherein each virtual button comprises six key values.

14. A 3D-input method for inputting information using a virtual keyboard comprising:
sensing the selection of a virtual button of the virtual keyboard by a user;
sensing positions of the user's fingers relative to the virtual button, and the order of the user's fingers that are used to select the virtual button; and
identifying a selected key value corresponding to the sensed positions of the fingers and the order of the user's fingers that are used to select the virtual button, amongst a plurality of stored key values.

15. The method of claim 14, further comprising outputting the selected key value.

16. The method of claim 14, wherein sensing the selection of a virtual button comprises arranging a plurality of sensors individually on the user's fingers and determining the position of those sensors relative to the virtual button.

17. The method of claim 14, wherein the plurality of stored key values are stored by:
mapping key values to respective predefined virtual buttons and a predefined order of the user's fingers used to select the predefined button.

18. The method of claim 17, wherein the virtual buttons are arranged so that the key values are ordered by frequency of use.

19. The method of claim 14, wherein the virtual buttons are arranged so that the key values are in alphabetical order.

20. The method of claim 14, wherein the virtual buttons include key values that are defined by the user.

21. The method of claim 14, wherein each virtual button comprises two key values.

22. The method of claim 14, wherein each virtual button comprises three key values.

23. The method of claim 14, wherein each virtual button comprises four key values.

24. The method of claim 14, wherein each virtual button comprises five key values.

25. The method of claim 14, wherein each virtual button comprises six key values.

26. A soft key mapping method for mapping keys onto virtual buttons of a virtual keyboard that are selected by a user's fingers upon which are individually mounted a plurality of sensors, the method comprising:
determining the number of sensors;
allocating key values according to the number of sensors;
mapping the allocated key values onto a first virtual button; and
repeating the determining, allocating and mapping for the remaining virtual buttons.

27. A virtual keyboard comprising a plurality of virtual buttons selectable by a user's fingers upon which are mounted a plurality of sensors, the virtual keyboard constructed by mapping key values onto each of the virtual buttons and arranging the virtual buttons according to a predetermined condition using a method comprising:
determining the number of sensors;
allocating key values to the number of sensors;
mapping the allocated key values onto a first virtual button; and
repeating the determining, allocating and mapping for the remaining virtual buttons.
